(19) United States
(12) Patent Application Publication
(10) Pub. No.: US 2025/0218411 A1
(43) Pub. Date: Jul. 3, 2025

(54) SPATIAL LIGHT MODULATION DEVICE

(71) Applicant: LG Display Co., Ltd., Seoul (KR)

(72) Inventor: Tsutomu ICHIKAWA, Kanagawa (JP)

(21) Appl. No.: 18/975,252

(22) Filed: Dec. 10, 2024

(30) Foreign Application Priority Data
Dec. 28, 2023 (JP) 2023-223155

(51) Int. Cl. G09G 3/36

(52) U.S. Cl. CPC G09G 3/3659; G09G 3/3614; G09G 3/3651; G09G 3/3696

(57) ABSTRACT

A spatial light modulation device includes: a light modulation portion including a plurality of pixels; a first driver supplying a first potential to the light modulation portion; a second driver supplying a second potential to the light modulation portion; and a voltage control portion supplying a third potential controlled in three stages to the light modulation portion, wherein the pixel includes: a first transistor whose conduction state is controlled by the first potential applied to its gate terminal; a second transistor whose conduction state is controlled by the second potential applied to its gate terminal when the conduction state of the first transistor is on; and a liquid crystal element in which a ferroelectric liquid crystal is interposed between a first electrode whose potential is set according to the conduction state of the second transistor, and a second electrode supplied with the third potential and facing the first electrode.

### CROSS-REFERENCE TO RELATED APPLICATIONS

The present application claims the priority benefit of Japanese Patent Application No. 2023-223155 filed on Dec. 28, 2023, which is hereby incorporated by reference in its entirety for all purposes as if fully set forth herein.

### BACKGROUND

### Technical Field

The present disclosure relates to a spatial light modulation device.

### Description of the Related Art

In general, a spatial light modulation device used in an image projection device, for example, a projector or holographic display is called an SLM (Spatial Light Modulator), and is used to spatially modulate phase or amplitude of coherent light using a liquid crystal cell. An example of an SLM using a liquid crystal cell is a reflective SLM using LCOS (Liquid Crystal On Silicon).

In the reflective SLM, a pixel is formed on silicon with a liquid crystal layer between a transparent electrode and a reflective electrode, and input light passing through the transparent electrode and the liquid crystal layer is reflected by the reflective electrode of each pixel to output modulated light. For example, when outputting two-level modulated light, ferroelectric liquid crystal (FLC) with spontaneous polarization is often used for the liquid crystal layer.

A pixel circuit of the SLM having the FLC can be formed based on, for example, a DRAM (Dynamic Random Access Memory) cell or an SRAM (Static Random Access Memory) cell. In the pixel circuit, a potential of the reflective electrode is controlled to 0 or a power potential according to a data, and a voltage between the reflective electrode and the transparent electrode is applied to the liquid crystal layer formed of the FLC. When the applied voltage reaches a driving voltage of the FLC, a polarization direction of the FLC can be reversed. Therefore, in order to make the voltage between the reflective electrode and the transparent electrode sufficiently large, a potential of the transparent electrode is generally fixed to half of the power potential. In addition, a pixel pitch to realize a practically sufficient viewing angle of 30° in a holographic display is 1 μm.

### BRIEF SUMMARY

However, in the SLM having the FLC, there is a problem that it is difficult to obtain a driving voltage for driving the FLC while attempting to narrow the pixel pitch, such as 1 μm pitch, for example. Narrowing the pixel pitch means reducing a size of a transistor in the pixel circuit, but generally, voltage withstand capability of the transistor decreases as it is reduced in size, so when narrowing the pixel pitch, it is necessary to lower the power potential. In addition, since the potential of the transparent electrode is fixed to half of the power potential regardless of whether the potential of the reflective electrode is controlled to 0 or the power potential, the voltage between the reflective electrode and the transparent electrode is only half the magnitude of the power potential at most. Therefore, as the pixel pitch is narrowed, it becomes difficult to obtain a voltage sufficient to reverse the polarization direction of the FLC.

In addition, for example, the pixel circuit based on a DRAM cell is configured to control the potential of the reflective electrode by a single transistor, so that an area of the pixel can be made small. However, even if it can be driven with a voltage capable of reversing polarization for an FLC of a large reverse current, a sufficiently large driving current is not obtained, and the reverse takes time, so that a frame rate becomes slow.

In addition, for example, the pixel circuit based on an SRAM cell can suppress a decrease in the frame rate by assigning data writing to the pixel and driving the FLC to other transistor. However, since it has a configuration having a plurality of transistors, an area of the pixel increases.

The present disclosure provides a spatial light modulation device which can apply a sufficient voltage to a liquid crystal while suppressing an increase in a pixel area.

Additional features and characteristics of the disclosure will be set forth in the description which follows, and in part will be apparent from the description, or may be learned by practice of the disclosure. These and other technical characteristics of the disclosure will be realized and attained by the structure particularly pointed out in the written description and claims hereof as well as the appended drawings.

As embodied and broadly described herein, a spatial light modulation device includes: a light modulation portion including a plurality of pixels; a first driver supplying a first potential to the light modulation portion; a second driver supplying a second potential to the light modulation portion; and a voltage control portion supplying a third potential controlled in three stages to the light modulation portion, wherein the pixel includes: a first transistor whose conduction state is controlled by the first potential applied to its gate terminal; a second transistor whose conduction state is controlled by the second potential applied to its gate terminal when the conduction state of the first transistor is on; and a liquid crystal element in which a ferroelectric liquid crystal is interposed between a first electrode whose potential is set according to the conduction state of the second transistor, and a second electrode supplied with the third potential and facing the first electrode.

It is to be understood that both the foregoing general description and the following detailed description are examples and explanatory and are intended to provide further explanation of the disclosure.

### BRIEF DESCRIPTION OF THE SEVERAL VIEWS OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 is a block diagram illustrating a configuration of a spatial light modulation device according to one embodiment of the present disclosure;

FIG. 2 is a view illustrating a partial cross-section of a configuration of a light modulation portion;

FIG. 3 is a view illustrating an example of a circuit configuration of a counter voltage generation portion;

FIG. 4 is a view illustrating a circuit configuration of a pixel;

FIG. 5 is a view illustrating a first example of a transition of a potential in a pixel;

FIG. 6 is a view illustrating a second example of a transition of a potential in a pixel;

FIG. 7 is a view illustrating a third example of a transition of a potential in a pixel;

FIG. 8 is a view illustrating a fourth example of a transition of a potential in a pixel;

FIG. 9 is a view illustrating a list of operations of a pixel;

FIGS. 10A and 10B illustrate a specific example of a voltage control method; and

FIG. 11 is a view illustrating a modified example of a circuit configuration of a pixel.

### DETAILED DESCRIPTION

Hereinafter, embodiments of the present disclosure are described in detail with reference to the drawings. Embodiments described below are examples and are not to be construed as being limited by this description.

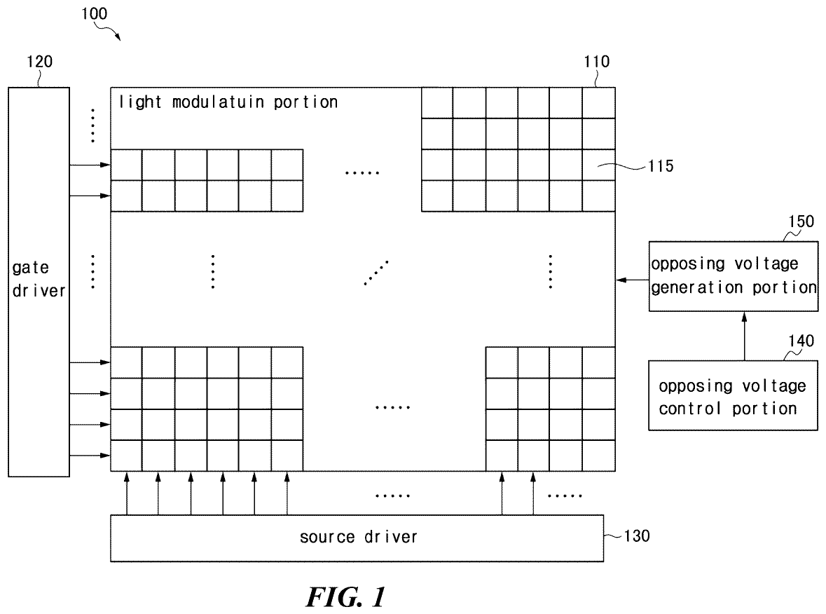

FIG. 1 is a block diagram illustrating a configuration of a spatial light modulation device according to one embodiment of the present disclosure. The spatial light modulation device 100 is equipped in, for example, an image projection device such as a holographic display, and spatially modulates a phase of input light and outputs it. The spatial light modulation device 100 shown in FIG. 1 has a light modulation portion 110, a gate driver 120, a source driver 130, an opposing voltage control portion 140, and an opposing voltage generation portion 150.

The light modulation portion 110 includes a pixel array in which a plurality of pixels 115 are two-dimensionally arranged in row direction and column direction. The light modulation portion 110 drives a liquid crystal element for each pixel 115 according to data written to each pixel 115 by the source driver 130, and spatially modulates the input light for each pixel 115.

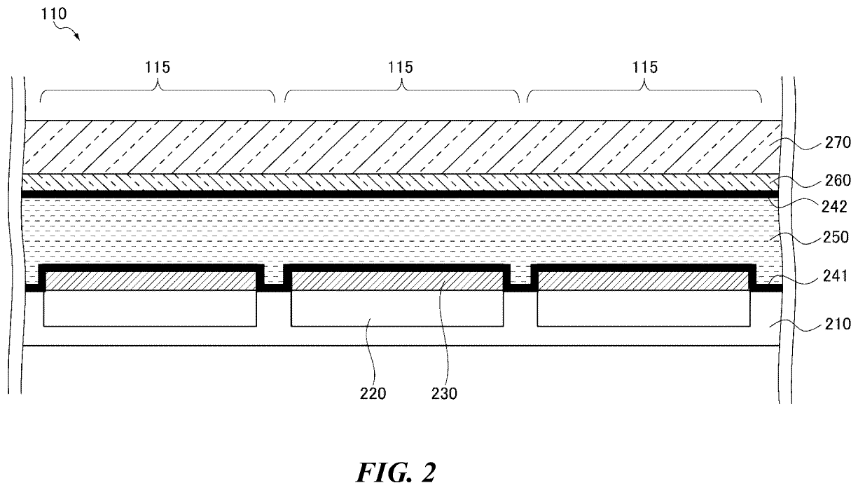

Specifically, the light modulation portion 110 has the configuration shown in FIG. 2. FIG. 2 is a view illustrating a partial cross-section of a light modulation portion. As shown in FIG. 2, the light modulation portion 110 is formed such that a pixel circuit 220, a reflective electrode 230, an alignment layer 241, a liquid crystal layer 250, an alignment layer 242, a transparent electrode 260, and a cover glass 270 are stacked on a silicon substrate 210. The pixel circuit 220 and the reflective electrode 230 are installed for each pixel 115.

The pixel circuit 220 is connected to the gate driver 120 and the source driver 130, and is a circuit including two transistors, such as MOSFETs (Metal-Oxide-Semiconductor Field-Effect Transistors). The pixel circuit 220 controls a potential of the reflective electrode 230 by switching conduction state of the two transistors, thereby controlling the writing of data to the pixel 115.

The reflective electrode 230 is an electrode formed of, for example, a metal such as aluminum, and reflects input light that passes through the cover glass 270, the transparent electrode 260, and the liquid crystal layer 250. The liquid crystal layer 250 is sandwiched between the reflective electrode 230 and the transparent electrode 260 facing the reflective electrode 230, thereby forming a liquid crystal element of the pixel 115. The potential of the reflective electrode 230 is controlled to a potential according to data by the pixel circuit 220.

The alignment layers 241 and 242 directly contacts the liquid crystal layer 250 and arranges a group of liquid crystal molecules forming the liquid crystal layer 250 in a predetermined direction.

The liquid crystal layer 250 is formed using a ferroelectric liquid crystal (FLC) having spontaneous polarization, and the polarization direction is reversed in the pixel 115 where the voltage between the reflective electrode 230 and the transparent electrode 260 reaches the driving voltage. The liquid crystal layer 250 changes transmittance to the input light according to the polarization direction of each pixel 115.

The transparent electrode 260 is a transparent electrode formed of, for example, indium tin oxide (ITO) and transmits the input light and the reflected light from the reflective electrode 230. The transparent electrode 260 is a single film-shaped electrode facing the plurality of reflective electrodes 230 installed for the respective pixels 115 and is connected to the opposing voltage generation portion 150. The potential of the transparent electrode 260 is controlled in three stages of positive power potential, 0, and negative power potential by the opposing voltage control portion 140 and the opposing voltage generation portion 150.

The cover glass 270 is a transparent member that covers the transparent electrode 260 and protects a surface of the light modulation portion 110. The input light input to the light modulation portion 110 is incident on the cover glass 270 from an outside, and the reflected light reflected by the reflective electrode 230 is output through the cover glass 270 to the outside.

Returning to FIG. 1, the gate driver 120 sequentially applies a gate voltage to the pixel array of the light modulation portion 110 one row at a time, and controls whether or not the data is written to the pixel 115 to which the gate voltage is applied.

When writing the data to each column of the pixel array of the light modulation portion 110, the source driver 130 supplies a data voltage according to the data, and controls the potential of the reflective electrode 230 equipped in the pixel 115.

The opposing voltage control portion 140 controls the opposing voltage to set the potential of the transparent electrode 260 to a desired potential. Specifically, when a frame of display data is started, the opposing voltage control portion 140 control to supply the negative power potential as the opposing voltage to the transparent electrode 260 in order to reset the polarization directions of the liquid crystal elements of all pixels 115. Then, while data writing to each pixel 115 is being executed, the opposing voltage control portion 140 controls to supply 0 as the opposing voltage to the transparent electrode 260, and when data writing to all pixels 115 is completed, the opposing voltage control portion 140 controls to supply the positive power potential as the opposing voltage to the transparent electrode 260. As such, the opposing voltage control portion 140 operates to supply three stages of the opposing voltage to the transparent electrode 260 and controls the potential of the transparent electrode 260 in three stages: the positive power potential, 0, and the negative power potential.

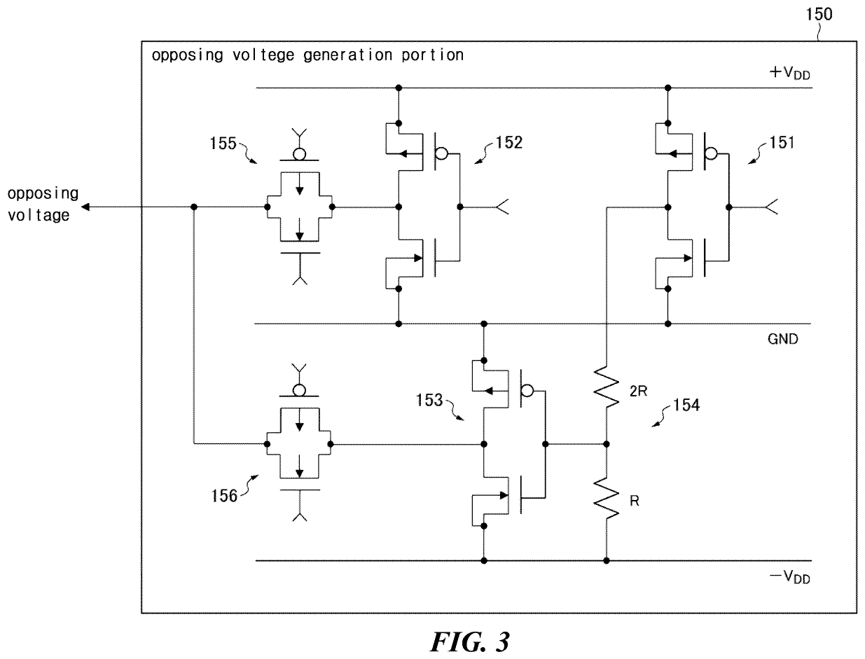

The opposing voltage generation portion 150 supplies the opposing voltage to the transparent electrode 260 according to the control of the opposing voltage control portion 140. That is, the opposing voltage generation portion 150 supplies three types of the opposing voltages, the positive power potential, 0, and the negative power potential, to the transparent electrode 260. Specifically, the opposing voltage generation portion 150 has a circuit configuration, for example, as shown in FIG. 3. As shown in FIG. 3, the opposing voltage generation portion 150 has inverter circuits 151 to 153, a voltage divider circuit 154, and transmission gate circuits 155 and 156.

The inverter circuit 151 is connected to a positive power potential +VDD and a ground potential GND, and supplies its output voltage to the voltage divider circuit 154.

The inverter circuit 152 is connected to the positive power potential +VDD and the ground potential GND, and supplies its output voltage to the transmission gate circuit 155.

The inverter circuit 153 is connected to the ground potential GND and a negative power potential −VDD, and supplies its output voltage to the transmission gate circuit 156.

The voltage divider circuit 154 has a resistance element having a resistance value ratio of 2:1, and divides a voltage between the output potential of the inverter circuit 151 and the negative power supply potential −VDD to supply its output voltage to the inverter circuit 153.

The transmission gate circuit 155 switches whether to supply the output voltage of the inverter circuit 152 to the transparent electrode 260.

The transmission gate circuit 156 switches whether to supply the output voltage of the inverter circuit 153 to the transparent electrode 260.

The operation of the inverter circuits 151, 152 and 153 and the transmission gate circuit 155 and 156 is controlled by the opposing voltage control portion 140, so that the opposing voltage generation portion 150 supplies one of the positive power supply potential +VDD, 0, and the negative power supply potential −VDD as the opposing voltage to the transparent electrode 260.

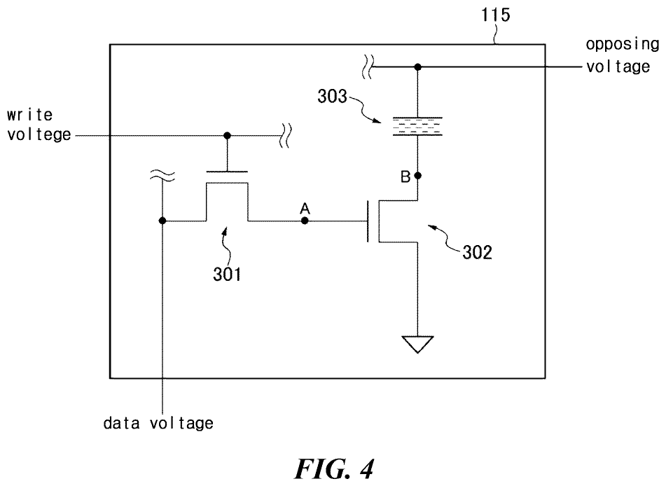

A configuration of the pixel 115 of the light modulation portion 110 is described in more detail. FIG. 4 is a view illustrating a circuit configuration of a pixel. The pixel 115 shown in FIG. 4 has transistors 301 and 302, and a liquid crystal element 303.

The transistor 301 is, for example, a field effect transistor such as a MOSFET, and has a gate terminal connected to the gate driver 120, a source terminal connected to the source driver 130, and a drain terminal connected to a node A. Thus, the transistor 301 is controlled in its conduction state by a write voltage from the gate driver 120, and when the conduction state is on, a voltage of the node A is set by a data voltage from the source driver 130. Since the node A is a node connected to a gate terminal of the transistor 302, a gate voltage according to the voltage of the node A is applied to the gate terminal of the transistor 302.

The transistor 302 is, for example, a field effect transistor such as a MOSFET, and has the gate terminal connected to the node A, a source terminal connected to a ground electrode, and a drain terminal connected to a node B. Thus, the transistor 302 is controlled in its conduction state by the voltage from the node A, and when the conduction state is on, a voltage of the node B is set by a ground voltage from the ground electrode. Since the node B is a node connected to the reflective electrode 230 of the liquid crystal element 303, when the conduction state of the transistor 302 is on, the potential of the reflective electrode 230 of the liquid crystal element 303 is set to 0, the same as the node B.

The liquid crystal element 303 is configured with the liquid crystal layer 250 interposed between the reflective electrode 230 and the transparent electrode 260, and drives the liquid crystal layer 250 by the voltage between the reflective electrode 230 and the transparent electrode 260. That is, when the voltage between the reflective electrode 230 and the transparent electrode 260 reaches the driving voltage, the liquid crystal element 303 can reverse the polarization direction of the liquid crystal molecules constituting the liquid crystal layer 250.

The polarization direction of the liquid crystal element 303 is reset to an initial state at a timing when the transistor 302 is in a conductive state, a potential VB of the node B is controlled to 0, and the opposing voltage becomes the negative power potential. After that, the polarization direction of the liquid crystal element 303 is maintained or reversed according to the potential state of the reflective electrode 230 at the timing when the transistor (302) is in a non-conductive state, the node B is in a high impedance (Hi-Z) state, and the opposing voltage becomes the positive power potential.

As such, since the pixel 115 is configured with the two transistors 301 and 302 and the liquid crystal element 303, the increase in the pixel area is suppressed. In particular, since the pixel circuit 220 needs to be equipped with the two transistors 301 and 302, the circuit size of the pixel circuit 220 is small, and a manufacturing cost of the spatial light modulation device 100 can be reduced.

The writing of data into the pixel 115 configured above is specifically described. First, for example, a case in which in order to write data “0” into the pixel 115, the polarization direction of the liquid crystal element 303 is set to, for example, a “−” direction is described.

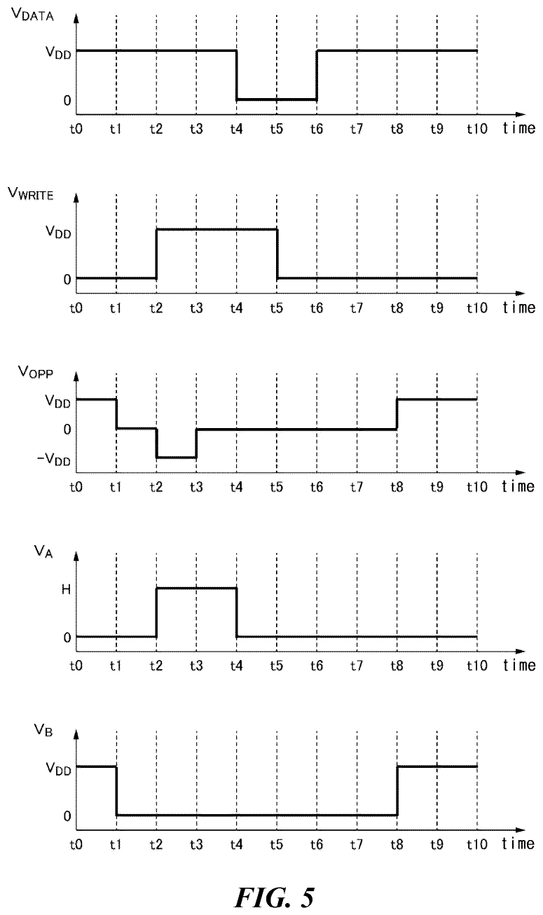

FIG. 5 is a view illustrating a first example of a transition of a potential of each node in a pixel. In FIG. 5, the transitions of a data voltage VDATA, a write voltage VWRITE, an opposing voltage VOPP, a potential VA of the node A, and a potential VB of the node B are shown in order from the top. The data voltage VDATA is controlled by the source driver 130, the write voltage VWRITE is controlled by the gate driver 120, and the opposing voltage VOPP is controlled by the opposing voltage control portion 140 and the opposing voltage generation portion 150.

The first example is a case in which, for example, at the start of a frame (i.e., a time t0), data “0” of the previous frame is written in the pixel 115, and the polarization direction of the liquid crystal element 303 is “−”. In this case, when the frame is started at the time t0, the potential VB of the node B equal to the potential of the reflective electrode 230 is the positive power potential +VDD.

From the time t0 to a time t1, the opposing voltage VOPP is set to the positive power potential +VDD continuously from the previous frame, and the potential of the transparent electrode 260 becomes the positive power potential +VDD. Then, from the time t1 to a time t2, the opposing voltage VOPP is set to 0, and accordingly, the potentials of the transparent electrode 260 and the reflective electrode 230 become 0. In addition, although the opposing voltage VOPP is set to 0 from the time t1 to the time t2 in this case, the opposing voltage VOPP may be set to the positive power potential +VDD until the time t2.

From the time t2 to a time t3, the polarization direction of the liquid crystal element 303 is reset to the initial state of the “−” direction. Specifically, the opposing voltage VOPP is set to the negative power potential −VDD, and the write voltage VWRITE is set to the positive power potential +VDD. By setting the write voltage VWRITE to the positive power potential +VDD, the conduction state of the transistor 301 is turned on, and before the data writing, the potential VA of the node A is set to a high potential by the data voltage VDATA that is set to the positive power potential +VDD. As a result, the conduction state of the transistor 302 is turned on, and the potential VB of the node B is set to 0 by the ground potential from the ground electrode.

Thus, the potential of the transparent electrode 260 is set to the negative power potential −VDD equal to the opposing voltage VOPP, and the potential of the reflective electrode 230 is set to 0 equal to the potential VB of the node B, so that the magnitude of the voltage between the reflective electrode 230 and the transparent electrode 260 becomes equal to the magnitude of the power potential. As a result, by making the magnitude of the power potential greater than the driving voltage of the liquid crystal layer 250, the polarization direction of the liquid crystal element 303 can be reset from the time t2 to the time t3. Here, since the data “0” was written in the previous frame, the polarization direction of the liquid crystal element 303 is the “−” direction, and even if reset, the polarization direction of the liquid crystal element 303 does not change.

From the time t3 to a time t4, the opposing voltage VOPP is set to 0, and accordingly, the potential of the transparent electrode 260 becomes 0. As a result, the magnitude of the voltage between the reflective electrode 230 and the transparent electrode 260 becomes 0, but the polarization direction of the liquid crystal element 303 is maintained in the “−” direction.

From the time t4 to a time t5, while the write voltage VWRITE is set to the positive power potential +VDD, the data voltage VDATA is set to 0 corresponding to the data “0”. As a result, the potential VA of the node A is set to 0 by the data voltage VDATA, the conduction state of the transistor 302 is turned off, and the node B is turned into the high impedance (Hi-Z) state. As a result, the pixel 115 is set to the data “0”.

From the time t5 to a time t6, the write voltage VWRITE returns to 0, and the conduction state of the transistor 301 is turned off. Even after the conduction state of the transistor 301 is turned off, the potential VA of the node A is maintained at 0. Thereafter, from the time t6 to a time t8, each potential passes (or is maintained) without change.

From the time t8 to a time t9, the polarization direction of the liquid crystal element 303 is set to reflect the data set in the pixel 115. Specifically, the opposing voltage VOPP is set to the positive power potential +VDD. By setting the opposing voltage VOPP to the positive power potential +VDD, the potential of the transparent electrode 260 becomes the positive power potential +VDD. In addition, since the conduction state of the transistor 302 is off, the potential VB of the node B in the high impedance Hi-Z state is not affected by the ground electrode and rises to the positive power potential +VDD identical to the potential of the transparent electrode 260.

Accordingly, since the potential of the transparent electrode 260 is set to the positive power potential +VDD equal to the opposing voltage VOPP, and the potential of the reflective electrode 230 rises to the positive power potential +VDD equal to the potential VB of the node B, the magnitude of the voltage between the reflective electrode 230 and the transparent electrode 260 becomes a small value close to 0. Due to this, the polarization direction of the liquid crystal element 303 is maintained without the voltage between the reflective electrode 230 and the transparent electrode 260 reaching the driving voltage of the liquid crystal layer 250. That is, in the liquid crystal element 303, the polarization direction is maintained in a state of the “−” direction corresponding to the data “0”.

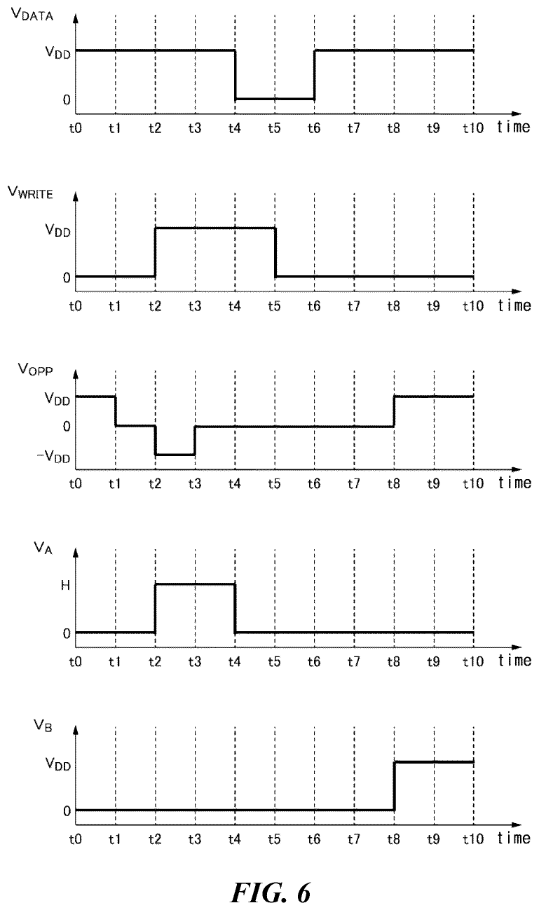

FIG. 6 is a view illustrating a second example of a transition of a potential of each node in a pixel. In FIG. 6, the transitions of the data voltage VDATA, the write voltage VWRITE, the opposing voltage VOPP, the potential VA of the node A, and the potential VB of the node B are shown in order from the top, similarly to FIG. 5.

The second example is a case in which, for example, at the start of a frame (i.e., a time t0), data “1” of the previous frame is written to the pixel 115, and the polarization direction of the liquid crystal element 303 is a “+” direction. In this case, when the frame is started at the time t0, the potential VB of the node B equal to the potential of the reflective electrode 230 is 0.

From the time t0 to a time t1, the opposing voltage VOPP is set to the positive power potential +VDD continuously from the previous frame, and the potential of the transparent electrode 260 becomes the positive power potential +VDD. Then, from the time t1 to a time t2, the opposing voltage VOPP is set to 0, and accordingly, the potentials of the transparent electrode 260 and the reflective electrode 230 become 0.

From the time t2 to a time t3, the polarization direction of the liquid crystal element 303 is reset to the initial state of the “−” direction. Specifically, the opposing voltage VOPP is set to the negative power potential −VDD, and the write voltage VWRITE is set to the positive power potential +VDD. By setting the write voltage VWRITE to the positive power potential +VDD, the conduction state of the transistor 301 is turned on, and before the data writing, the potential VA of the node A is set to a high potential by the data voltage VDATA that is set to the positive power potential +VDD. As a result, the conduction state of the transistor 302 is turned on, and the potential VB of the node B is set to 0 by the ground potential from the ground electrode.

Thus, the potential of the transparent electrode 260 is set to the negative power potential −VDD equal to the opposing voltage VOPP, and the potential of the reflective electrode 230 is set to 0 equal to the potential VB of the node B, so that the magnitude of the voltage between the reflective electrode 230 and the transparent electrode 260 becomes equal to the magnitude of the power potential. As a result, by making the magnitude of the power potential greater than the driving voltage of the liquid crystal layer 250, the polarization direction of the liquid crystal element 303 can be reset from the time t2 to the time t3. Here, since the data “1” was written in the previous frame, the polarization direction of the liquid crystal element 303 is the “+” direction opposite to the “−” direction, and the polarization direction of the liquid crystal element 303 is reversed by the reset. That is, the polarization direction of the liquid crystal element (303) is reset to the “−” direction corresponding to the data “0”.

Thereafter, like the first example described above, from a time t4 to a time t5, the conduction state of the transistor 302 is turned off, and the pixel 115 is set to a state where data “0” is set. Then, from a time t8 to a time t9, the opposing voltage VOPP is set to the positive power potential +VDD, so that the potential of the transparent electrode 260 becomes the positive power potential +VDD, and the potential of the reflective electrode 230 rises to the positive power potential +VDD. As a result, the polarization direction of the liquid crystal element 303 is maintained without the voltage between the reflective electrode 230 and the transparent electrode 260 reaching the driving voltage of the liquid crystal layer 250. That is, in the liquid crystal element 303, the polarization direction is maintained in a state of the “−” direction corresponds to the data “0”.

Hereinafter, a case in which, for example, in order to write data “1” to the pixel 115, the polarization direction of the liquid crystal element 303 is set to the “+” direction opposite to the “−” direction is described.

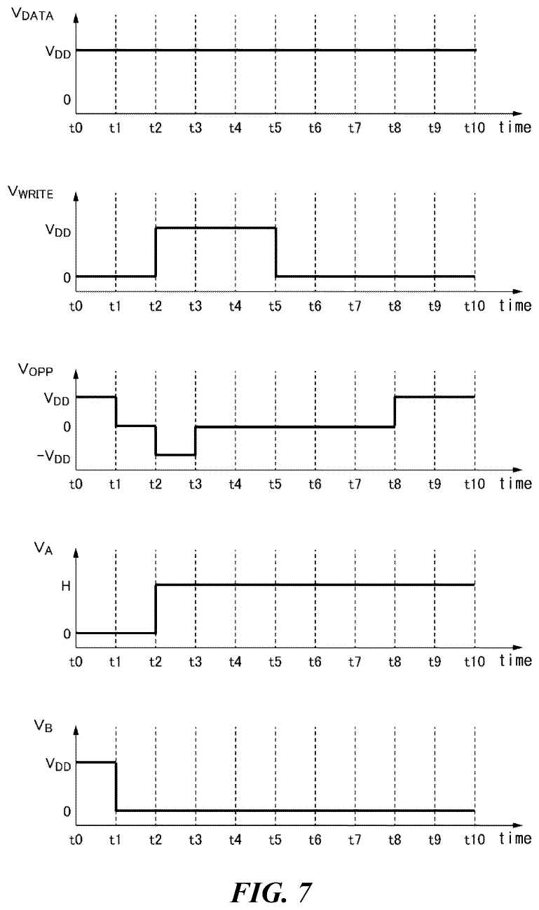

FIG. 7 is a view illustrating a third example of a transition of a potential of each node in a pixel. In FIG. 7, the transitions of the data voltage VDATA, the write voltage VWRITE, the opposing voltage VOPP, the potential VA of the node A, and the potential VB of the node B are shown in order from the top, similarly to FIG. 5.

The third example is a case in which, for example, at the start of the frame (i.e., a time t0), data “0” of the previous frame is written to the pixel 115, and the polarization direction of the liquid crystal element 303 is a “−” direction. In this case, when the frame is started at the time t0, the potential VB of the node B equal to the potential of the reflective electrode 230 is the positive power potential +VDD.

From the time t0 to a time t1, the opposing voltage VOPP is set to the positive power potential +VDD continuously from the previous frame, and the potential of the transparent electrode 260 becomes the positive power potential +VDD. Then, from the time t1 to a time t2, the opposing voltage VOPP is set to 0, and accordingly, the potentials of the transparent electrode 260 and the reflective electrode 230 become 0.

From the time t2 to a time t3, the polarization direction of the liquid crystal element 303 is reset to the initial state of the “−” direction. Specifically, the opposing voltage VOPP is set to the negative power potential −VDD, and the write voltage VWRITE is set to the positive power potential +VDD. By setting the write voltage VWRITE to the positive power potential +VDD, the conduction state of the transistor 301 is turned on, and before the data writing, the potential VA of the node A is set to a high potential by the data voltage VDATA that is set to the positive power potential +VDD. As a result, the conduction state of the transistor 302 is turned on, and the potential VB of the node B is set to 0 by the ground potential from the ground electrode.

Thus, the potential of the transparent electrode 260 is set to the negative power potential −VDD equal to the opposing voltage VOPP, and the potential of the reflective electrode 230 is set to 0 equal to the potential VB of the node B, so that the magnitude of the voltage between the reflective electrode 230 and the transparent electrode 260 becomes equal to the magnitude of the power potential. As a result, by making the magnitude of the power potential greater than the driving voltage of the liquid crystal layer 250, the polarization direction of the liquid crystal element 303 can be reset from the time t2 to the time t3. Here, since the data “0” was written in the previous frame, the polarization direction of the liquid crystal element 303 is the “−” direction, and even if reset, the polarization direction of the liquid crystal element 303 does not change.

From the time t3 to a time t4, the opposing voltage VOPP is set to 0, and accordingly, the potential of the transparent electrode 260 becomes 0. As a result, the magnitude of the voltage between the reflective electrode 230 and the transparent electrode 260 becomes 0, but the polarization direction of the liquid crystal element 303 is maintained in the “−” direction.

From the time t4 to a time t5, while the write voltage VWRITE is set to the positive power potential +VDD, the data voltage VDATA is set to the positive power potential +VDD corresponding to the data “1”. As a result, the potential VA of the node A is set to a high potential by the data voltage VDATA, and the conduction state of the transistor 302 is turned on. As a result, the pixel 115 is set to the data “1”.

From the time t5 to a time t6, the write voltage VWRITE returns to 0, and the conduction state of the transistor 301 is turned off. Even after the conduction state of the transistor 301 is turned off, the potential VA of the node A is maintained in the high potential state. Thereafter, from the time t6 to a time t8, each potential passes (or is maintained) without change.

From the time t8 to a time t9, the polarization direction of the liquid crystal element 303 is set to reflect the data set in the pixel 115. Specifically, the opposing voltage VOPP is set to the positive power potential +VDD. By setting the opposing voltage VOPP to the positive power potential +VDD, the potential of the transparent electrode 260 becomes the positive power potential +VDD. In addition, since the conduction state of the transistor 302 is on, the potential VB of the node B is maintained at 0 regardless of the potential of the transparent electrode 260.

Accordingly, since the potential of the transparent electrode 260 is set to the positive power potential (+VDD) equal to the opposing voltage VOPP, and the potential of the reflective electrode 230 is set to 0 equal to the potential VB of the node B, the magnitude of the voltage between the reflective electrode 230 and the transparent electrode 260 becomes equal to the magnitude of the power potential. Accordingly, by making the magnitude of the power potential greater than the driving voltage of the liquid crystal layer 250, the polarization direction of the liquid crystal element 303 can be reversed. That is, the polarization direction of the liquid crystal element 303, which is reset in the “−” direction, can be reversed to the “+” direction corresponding to the data “1”.

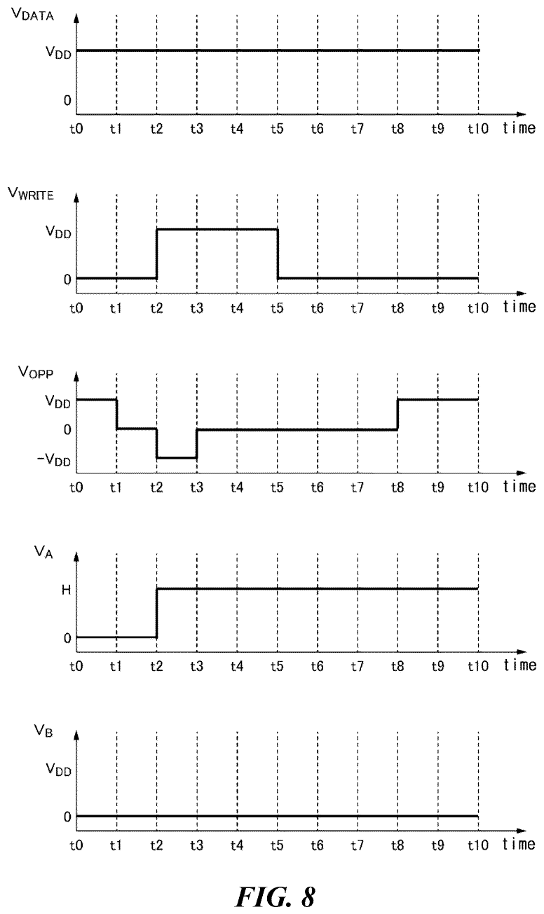

FIG. 8 is a view illustrating a fourth example of a transition of a potential of each node in a pixel. In FIG. 8, the transitions of the data voltage VDATA, the write voltage VWRITE, the opposing voltage VOPP, the potential VA of the node A, and the potential VB of the node B are shown in order from the top, similarly to FIG. 5.

The fourth example is a case in which, for example, at the start of a frame (i.e., a time t0), data “1” of the previous frame is written to the pixel 115, and the polarization direction of the liquid crystal element 303 is a “+” direction. In this case, when the frame is started at the time t0, the potential VB of the node B equal to the potential of the reflective electrode 230 is 0.

From the time t0 to a time t1, the opposing voltage VOPP is set to the positive power potential +VDD continuously from the previous frame, and the potential of the transparent electrode 260 becomes the positive power potential +VDD. Then, from the time t1 to a time t2, the opposing voltage VOPP is set to 0, and accordingly, the potentials of the transparent electrode 260 and the reflective electrode 230 become 0.

From the time t2 to a time t3, the polarization direction of the liquid crystal element 303 is reset to the initial state of the “−” direction. Specifically, the opposing voltage VOPP is set to the negative power potential −VDD, and the write voltage VWRITE is set to the positive power potential +VDD. By setting the write voltage VWRITE to the positive power potential +VDD, the conduction state of the transistor 301 is turned on, and before the data writing, the potential VA of the node A is set to a high potential by the data voltage VDATA that is set to the positive power potential +VDD. As a result, the conduction state of the transistor 302 is turned on, and the potential VB of the node B is set to 0 by the ground potential from the ground electrode.

Thus, the potential of the transparent electrode 260 is set to the negative power potential −VDD equal to the opposing voltage VOPP, and the potential of the reflective electrode 230 is set to 0 equal to the potential VB of the node B, so that the magnitude of the voltage between the reflective electrode 230 and the transparent electrode 260 becomes equal to the magnitude of the power potential. As a result, by making the magnitude of the power potential greater than the driving voltage of the liquid crystal layer 250, the polarization direction of the liquid crystal element 303 can be reset from the time t2 to the time t3. Here, since the data “1” was written in the previous frame, the polarization direction of the liquid crystal element 303 is the “+” direction, and the polarization direction of the liquid crystal element (303) is reversed by the reset. That is, the polarization direction of the liquid crystal element (303) is reset to the “−” direction corresponding to the data “0”.

Thereafter, like the third example described above, from a time t4 to a time t5, the conduction state of the transistor 302 is turned on, and the pixel 115 is set to a state where data “1” is set. Then, at a time t8 to a time t9, the opposing voltage VOPP is set to the positive power potential +VDD, so that the potential of the transparent electrode 260 becomes the positive power potential +VDD, and the potential of the reflective electrode 230 is maintained at 0. As a result, the magnitude of the voltage between the reflective electrode 230 and the transparent electrode 260 becomes equal to the magnitude of the power potential, and the polarization direction of the liquid crystal element 303 is reversed. That is, in the liquid crystal element 303, the polarization direction is set to the “+” direction corresponding to the data “1”.

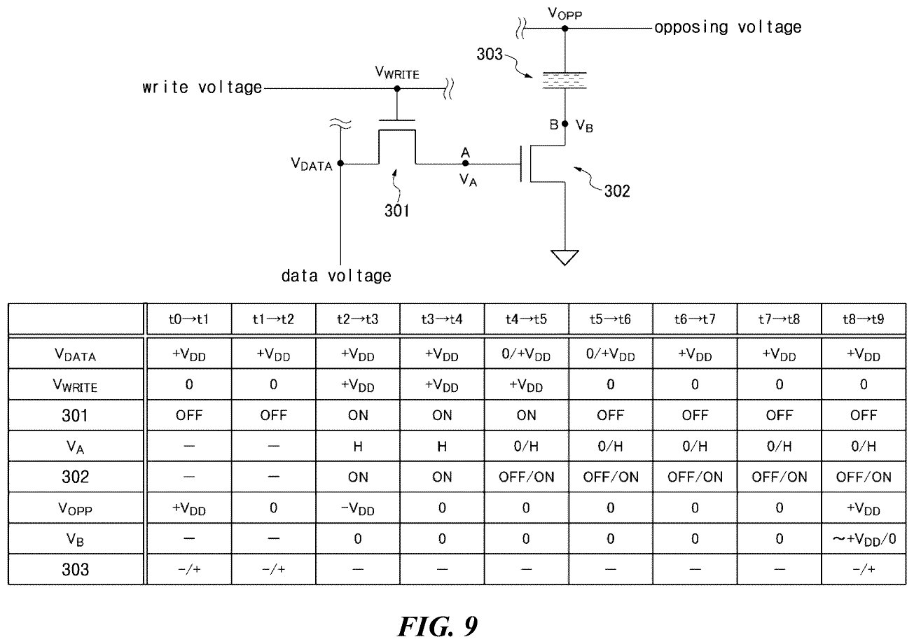

The transition of the potential in the pixel 115 as above is summarized as shown in FIG. 9. FIG. 9 illustrates a data voltage, a write voltage, an opposing voltage, a potential of a node, and a potential of a node and a conduction state of transistors and a polarization direction of a liquid crystal element at each time in FIGS. 5 to 8.

As can be seen from FIG. 9, in both the case where the data “0” is written to the pixel 115 and the case where data “1” is written to the pixel 115, the opposing voltage VOPP transitions in the same way. That is, from the time t2 to the time t3 when the polarization direction of the liquid crystal element 303 is reset, the opposing voltage VOPP is set to the negative power potential −VDD, and from the time t3 to the time t8 when the data “0” or “1” is set to the pixel 115, the opposing voltage VOPP is set to 0. In addition, after the time t8 when the polarization direction of the liquid crystal element 303 is set according to the data, the opposing voltage VOPP is set to the positive power potential +VDD.

In addition, from the time t2 to the time t3, the conduction states of the transistors 301 and 302 both becomes on, and the potential VB of the node B becomes 0, so that, regardless of the polarization direction before the time t2, the polarization direction of the liquid crystal element 303 is reset to, for example, a “−” direction of (indicated by “−” in FIG. 9). Accordingly, it becomes possible to write data to the pixel 115 without being affected by the previous frame, and the input light to the light modulation portion 110 can be spatially modulated reliably.

In addition, from the time t4 to the time t5, the conduction state of the transistor 301 becomes on, and the potential VA of the node A is set to 0 or a high potential (indicated by “H” in FIG. 9) depending on the data voltage VDATA. As a result, the conduction state of the transistor 302 after the time t4 is determined, and it is set whether the potential VB of the node B is maintained at the ground potential or rises according to the potential of the transparent electrode 260. Accordingly, the data “0” or “1” is set to the pixel 115.

In addition, from the time t8 to the time t9, the potential VB of the node B becomes the potential according to the data set to the pixel 115, and the magnitude of the voltage between the reflective electrode 230 and the transparent electrode 260 (i.e., the difference between the potential VB of the node B and the opposing voltage VOPP) becomes approximately 0 or a value equal to the power potential. When the magnitude of this voltage is approximately 0, the liquid crystal layer 250 is not driven, and the polarization direction of the liquid crystal element 303 is in the “−” state without change. Meanwhile, when the magnitude of this voltage is equal to the power potential, the liquid crystal layer 250 is driven so that the polarization direction of the liquid crystal element 303 is reversed from “−” to “+”. As such, the voltage equal to the power potential can be applied when reversing the polarization direction of the liquid crystal element 303, so that a sufficiently large voltage can be applied to the liquid crystal layer (250) to reverse the polarization direction.

Meanwhile, since the light modulation portion 110 includes the pixel array in which the plurality of pixels 115 are arranged two-dimensionally in the row direction and the column direction, the data writing to each pixel 115 is executed sequentially. At this time, it is possible to reset the polarization direction for the pixels 115 of all rows at the same time, and then write data to the pixels (115) by row. Hereinafter, a specific example is described.

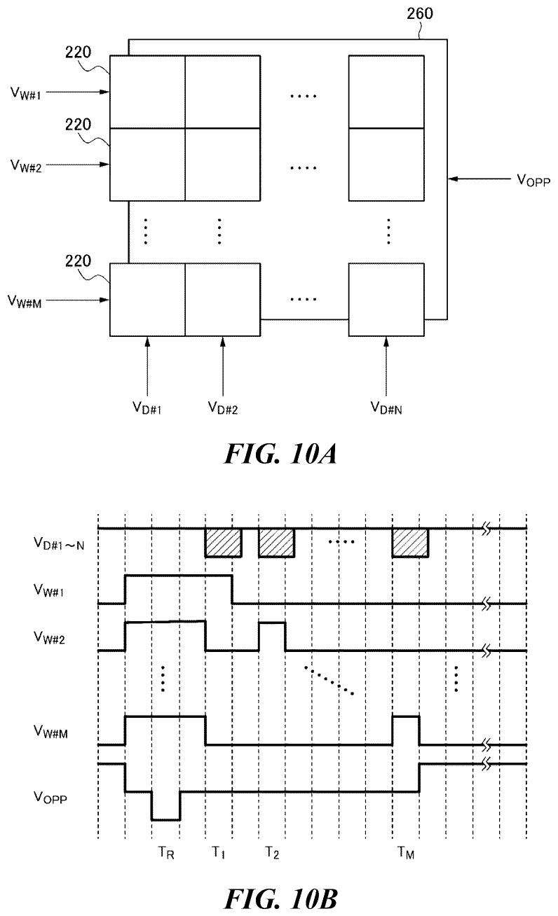

In a case where the pixel array of the light modulation portion 110 has the pixels 115, for example, of M rows and N columns (where M and N are integers of 2 or more) as shown in FIG. 10A, the write voltages VWRITE supplied from the gate driver 120 to the pixel circuits 220 of the rows are referred to as voltages VW#1 to VW#M, respectively, and the data voltages VDATA supplied from the source driver 130 to the pixel circuits 220 of the columns are referred to as voltages VD#1 to VD#N, respectively. The opposing voltage VOPP is supplied from the opposing voltage generation portion 150 to one transparent electrode 260 facing the pixel circuits 220 and the reflective electrodes 230.

In the pixel array, as shown in FIG. 10B, in a time (or interval) TR, the polarization directions of all pixels 115 are reset. That is, the write voltages VW#1 to VW#M of all rows are set to the positive power potential +VDD, and the opposing voltage VOPP is set to the negative power potential −VDD, so that the polarization directions of all pixels 115 are reset to the initial state.

Then, while the opposing voltage VOPP is set to 0, data are set in the pixel circuits 220 row by row. That is, in a time (or interval) T1, the write voltage VW#1 supplied to the pixel circuits 220 of the first row becomes the positive power potential +VDD, and during this time, the data voltages VD#1 to VD#N are supplied to the pixel circuits (220) of the respective columns in the first row. In addition, at a time (or interval) T2, the write voltage VW#2 supplied to the pixel circuits 220 of the second row becomes the positive power potential +VDD, and during this time, the data voltages VD#1 to VD#N are supplied to the pixel circuits 220 of the respective columns in the second row. Thereafter, the same data setting is executed, and at a time (or interval) TM, the write voltage VW#M supplied to the pixel circuits 220 of the Mth row becomes the positive power potential +VDD, and during this time, the data voltages VD#1 to VD#N are supplied to the pixel circuits 220 of the respective columns in the Mth row.

When the data setting to the pixel circuits 220 of all rows is completed, the opposing voltage VOPP is set to the positive power potential +VDD. Accordingly, the polarization direction of each pixel 115 is maintained or reversed according to the data set in each pixel circuit 220, and modulation of the input light in the entire light modulation portion 110 is performed.

As such, by commonly controlling the opposing voltage VOPP supplied to the transparent electrode 260 for the plurality of pixels 115, the polarization directions in the plurality of pixels 115 can be individually controlled.

As described above, according to the present embodiment, the pixel of the light modulation portion includes the two transistors that switch their conduction states according to the write voltage and the data voltage, and a liquid crystal element in which the ferroelectric liquid crystal is sandwiched between the reflective electrode whose potential is controlled by the transistors and the opposing electrode whose potential is controlled in three stages. In addition, for each frame, the polarization direction of the liquid crystal element is reset, and then data is written to the pixel to set the polarization direction. Accordingly, the liquid crystal element can be driven by a voltage equivalent to the power potential, and sufficient voltage can be applied to the liquid crystal while suppressing the increase in the pixel area.

In addition, the transparent electrode 260 may be configured of a single electrode as in the above-described embodiment, or may be configured of a plurality of electrodes divided into multiple parts in the row direction. In that case, the opposing voltage VOPP supplied from the opposing voltage generation portion 150 may also be supplied by dividing it into the same number as the number of divisions of the opposing electrode. In addition, the timing at which the opposing voltage VOPP is set from 0 to the positive power potential +VDD in order to set the polarization direction according to the data written in the pixel may be different for each of the divided electrodes. Accordingly, the number of pixels driven by the opposing voltage generation portion 150 per opposing voltage is reduced, and the opposing voltage VOPP can be supplied with more leeway.

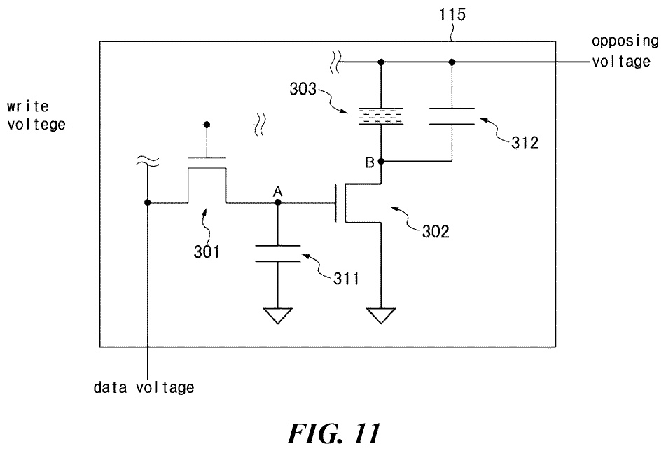

In addition, although the pixel 115 according to the above embodiment has the two transistors 301 and 302 and the liquid crystal element 303, the pixel 115 may have other circuit elements. FIG. 11 is a view illustrating a modified example of a pixel. In FIG. 11, the same parts as in FIG. 4 are given the same symbols.

The pixel 115 shown in FIG. 11 has a configuration in which capacitors 311 and 312 are added to the pixel 115 shown in FIG. 4.

The capacitor 311 is interposed between the node A and the ground electrode. By installing the capacitor 311, when the potential VA of the node (A) is set to a high potential and then the conduction state of the transistor 301 is turned off, the high potential of the node A can be maintained more stably.

The capacitor 312 is installed in parallel with the liquid crystal element 303 between the node B and the opposing voltage. By installing the capacitor 312, when the conduction state of the transistor 302 is turned off, influence of a parasitic capacitance of the transistor 302 on the potential VB of the node B can be reduced, and the potential of the reflective electrode 230 can rise more stably in accordance with the potential of the transparent electrode 260.

One of these capacitors 311 and 312 may be installed in the pixel 115. In addition, since the capacitors 311 and 312 are relatively small circuit elements, the increase in the pixel area due to installing the capacitors 311 and 312 in the pixel 115 is limited.

In the above embodiment, when the pixel 115 is reset, the opposing voltage VOPP is set to the negative power potential −VDD, and when the polarization direction of the pixel 115 is set, the opposing voltage VOPP is set to the positive power potential +VDD, but the setting of the opposing voltage VOPP is not limited to this. That is, for example, it is also possible to set the opposing voltage VOPP to the positive power potential +VDD when the reset is made, and to the opposing voltage VOPP to the negative power potential −VDD when the polarization direction is set. In this case, by reversing other potential such as the data voltage VDATA or changing the alignment of the liquid crystal molecule group by the alignment layers 241 and 242, the liquid crystal element can be driven by a voltage equivalent to the power potential, as in the above embodiment.

According to the present disclosure as above, sufficient voltage can be applied to the liquid crystal while suppressing the increase in the pixel area.

It will be apparent to those skilled in the art that various modifications and variation can be made in the present disclosure without departing from the spirit or scope of the disclosure. Thus, it is intended that the present disclosure including the appended claims cover the modifications and variations of this disclosure and their equivalents.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A spatial light modulation device, comprising:
a light modulation portion including a plurality of pixels;
a first driver for supplying a first potential to the light modulation portion;
a second driver for supplying a second potential to the light modulation portion; and
a voltage control portion for supplying a third potential controlled in three stages to the light modulation portion,
wherein a pixel of the plurality of pixels includes:
a first transistor whose conduction state is connected to be controlled by the first potential applied to its gate terminal;
a second transistor whose conduction state is connected to be controlled by the second potential applied to its gate terminal when the conduction state of the first transistor is on; and
a liquid crystal element in which a ferroelectric liquid crystal is interposed between a first electrode whose potential is connected to be set according to the conduction state of the second transistor, and a second electrode connected to be supplied with the third potential and facing the first electrode.

2. The spatial light modulation device of claim 1, wherein the pixel further includes a capacitive element connected between the gate terminal of the second transistor and a ground electrode.

3. The spatial light modulation device of claim 1, wherein the pixel further includes a capacitive element connected in parallel with the liquid crystal element.

4. The spatial light modulation device of claim 1, wherein the voltage control portion is configured to supply the third potential of a first stage to the second electrode to reset a polarization direction of the liquid crystal element by, and then to supply the third potential of a second stage to the second electrode to set data to the pixel.

5. The spatial light modulation device of claim 4, wherein the voltage control portion is configured to supply the third potential of a third stage, which is positively or negatively inverted from the third potential of the first stage, to the second electrode to maintain or reverse the polarization direction of the liquid crystal element based on the data set to the pixel.

6. The spatial light modulation device of claim 1, wherein the ferroelectric liquid crystal of the liquid crystal element is interposed between the first electrode of each pixel of the plurality of pixels and the second electrode commonly facing the first electrodes of the plurality of pixels.
